(19) United States
(12) Patent Application Publication
(10) Pub. No.: US 2008/0309758 A1
(43) Pub. Date: Dec. 18, 2008

(54) ENDOSCOPE SYSTEM, CAMERA SET ON BODY CAVITY INNER WALL AND METHOD OF SETTING THE CAMERA SET ON BODY CAVITY INNER WALL ON INNER SURFACE OF BODY CAVITY WALL

(75) Inventors: Hitoshi Karasawa, Tokyo (JP); Keiji Handa, Tokyo (JP); Daisuke Asada, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS MEDICAL SYSTEMS CORP., Tokyo (JP)

(21) Appl. No.: 12/132,943

(22) Filed: Jun. 4, 2008

(30) Foreign Application Priority Data
Jun. 14, 2007 (JP) 2007-157947

(51) Int. Cl. H04N 7/18

(52) U.S. Cl. 348/65; 348/E07.085

(57) ABSTRACT

An endoscope system has a camera which picks up an image in a body cavity, and a needle portion which is an electrode for transmitting a signal picked up by the camera, and which is pierced through a body wall, to transmit the signal from the camera to the outside of the body cavity.

### CROSS REFERENCE TO RELATED APPLICATION

This application claims benefit of Japanese Patent Application No. 2007-157947 filed on Jun. 14, 2007 the contents of which are incorporated by this reference.

### BACKGROUND OF THE INVENTION

1. Field of the Invention

The present invention relates to an endoscope system provided with an image pickup apparatus capable of viewing a wide area in an abdominal cavity and fixed inside a body cavity wall.

2. Description of the Related Art

In recent years, laparoscopic surgical operations in which an abdominal portion of a patient is punctured with a trocar for introducing an endoscope for observation into a body cavity and a trocar for introducing a treatment instrument to a portion to be treated and a treatment is performed while observing the treatment instrument and the portion to be treated through the endoscope have been performed as non-dissection operations in order to reduce invasiveness into patients. This method has a problem that the field of view of an endoscope through which observations can be actually made is comparatively narrow and, hence, a problem that it is difficult to widely observe the whole of a portion to be treated and correctly grasp, for example, the positional relationship between a treatment instrument and an internal organ.

Japanese Patent Laid-Open No. 7-194602 discloses an abdominal wall lifter devised to solve this problem. In the abdominal wall lifter, an illumination window is provided generally at a center of an insertion portion of the main body of the lifter, and observation units are provided on both sides of the illumination window. The main body of the lifter lifts an abdominal wall by means of the insertion portion inserted in an abdominal cavity, as shown in FIG. 1A of Japanese Patent Laid-Open No. 7-194602. Therefore, an image obtained through observation units provided on the insertion portion of the main body of the lifter is an image in which the cavity space in the abdominal cavity is viewed vertically downward, thus obtaining a wider field of view in comparison with images obtained through the conventional scopes.

### SUMMARY OF THE INVENTION

A first endoscope system according to the present invention includes an image pickup unit for picking up an image in a body cavity, and a puncturing portion having an electrode for transmitting a signal picked up by the image pickup unit, with the puncturing portion transmitting the signal from the image pickup unit to the outside of the body cavity through a body wall.

A camera set on body cavity inner wall according to the present invention includes an image pickup portion which picks up an image in a body cavity, a signal transmitting portion which transmits a signal from the image pickup portion to the outside of the body cavity through a body wall, a base portion provided integrally with the image pickup portion and formed of an elastic member larger in diameter than the image pickup portion, a cover portion in the form of a sack formed integrally with the base portion and covering the signal transmitting portion extended from the image pickup portion on the extended portion side of the signal transmission portion, and a stopper member having an engagement portion to be engaged into the signal transmitting portion.

A method of setting a camera set on body cavity inner wall on an inner surface of a body cavity wall according to the present invention includes a manual operation to place, in a small dissected portion formed in a body cavity wall, an outer cover having a central channel forming portion which enables communication between the inner surface side and the outer surface side of the body cavity wall, a manual operation to introduce an image pickup portion which picks up an image in a body cavity into the body cavity from the outer surface side to the inner surface side of the body cavity wall via the central channel forming portion of the outer cover by placing a finger in a cover portion which is provided integrally with the image pickup portion, and which covers a signal transmitting portion extended from an the image pickup portion on the extended portion side of the signal transmitting portion, a manual operation to adjust an image pickup range of the image pickup portion by operating at least one of the cover portion, the signal transmitting portion and the outer cover so that a base portion provided integrally with the image pickup portion introduced on the inner surface side of the body cavity wall is drawn into abutment on an inner surface of the body cavity wall, and a manual operation to position the image pickup portion by causing an engagement portion to engage into the signal transmitting portion of the image pickup portion having the image pickup range adjusted.

The above and other objects, features and advantages of the invention will become more clearly understood from the following description referring to the accompanying drawings.

### BRIEF DESCRIPTION OF THE DRAWINGS

FIG. 1 is a diagram showing an endoscope system according to a first embodiment of the present invention;

FIG. 2 is a diagram showing a camera set on body cavity inner wall;

FIG. 3 is a sectional view of the configuration of a camera cable;

FIG. 4 is a diagram showing a state in which a camera set on body cavity inner wall is set on a body cavity wall;

FIG. 5 is a diagram showing a camera attachment/detachment forceps;

FIG. 6 is a diagram showing the configuration of a distal end portion of the camera attachment/detachment forceps and the function of a camera receiving portion provided in the distal end portion;

FIG. 7 is a diagram showing an abdominal wall pierced with trocars;

FIG. 8 is a diagram showing a state in which, to retain the camera on an abdominal wall, a rigid endoscope is inserted in one trocar while the camera attachment/detachment forceps having the camera body placed in the camera receiving portion is inserted in the other trocar;

FIG. 9 is a diagram showing a state in which a needle portion of the camera is opposed to an inner surface of an abdominal wall by operating the camera attachment/detachment forceps;

FIG. 10 is a diagram showing a state in which the abdominal wall is punctured with the needle portion of the camera from the inner surface side of the abdominal wall, and in which the needle portion projects from the outer surface of the abdominal wall;

FIG. 11 is a diagram showing a state in which a camera-side connector is attached to the needle portion projecting from the outer surface of the abdominal wall;

FIG. 12 is a diagram showing a state in which an operation is performed by inserting the rigid endoscope in one trocar and by inserting a grasping forceps in the other trocar;

FIG. 13 is a diagram showing a camera of a different configuration having three needle portions, a stopper disk of a different configuration corresponding to the camera and a camera side connector of a different configuration corresponding to the camera;

FIG. 14 is a diagram showing an endoscope system according to a second embodiment of the present invention;

FIG. 15 is a diagram showing the configuration of a camera cable;

FIG. 16 is a partially sectional view showing a camera set on body cavity inner wall;

FIG. 17 is a diagram showing a state in which the camera set on body cavity inner wall is set on a body cavity wall;

FIG. 18 is a diagram showing a state in which an abdominal wall is punctured from an outer surface of an abdominal wall to the interior of an abdominal cavity with a needle portion provided at one end of the camera cable in a state in which, to retain the camera on the abdominal wall, a rigid endoscope is inserted in one trocar while a camera attachment/detachment forceps having the camera body placed in a camera receiving portion is inserted in the other trocar;

FIG. 19 is a diagram showing a state in which the camera is attached to the needle portion with which the abdominal wall is punctured;

FIG. 20 is a diagram showing a state in which the needle portion provided at one end of the camera cable is drawn out of the abdominal wall and the camera is detached in the abdominal wall;

FIG. 21 is a diagram showing an endoscope system according to a third embodiment of the present invention;

FIG. 22 is a diagram showing a camera with a finger sack;

FIG. 23 is a diagram showing forming of a small dissected portion on the abdominal wall with a surgical knife;

FIG. 24 is a diagram showing a state in which an outer cover is placed by being forced into the small dissected portion;

FIG. 25 is a diagram showing a state in which a finger is inserted in the finger sack of the camera;

FIG. 26 is a diagram showing a state in which the camera is forced into an abdominal cavity through a center channel provided to the outer cover;

FIG. 27 is a diagram showing a state in which the camera is inserted in the abdominal cavity; and

FIG. 28 is a diagram showing a state in which the camera is set in the abdominal cavity.

### DETAILED DESCRIPTION OF THE PREFERRED EMBODIMENTS

Embodiments of the present invention will be described with reference to the accompanying drawings.

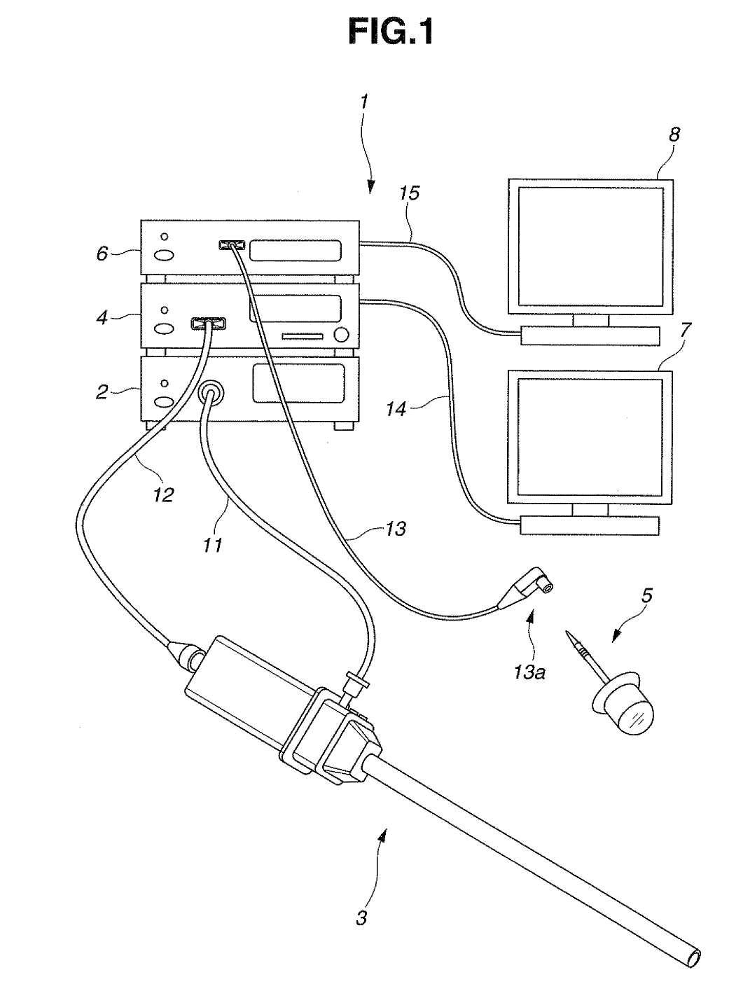

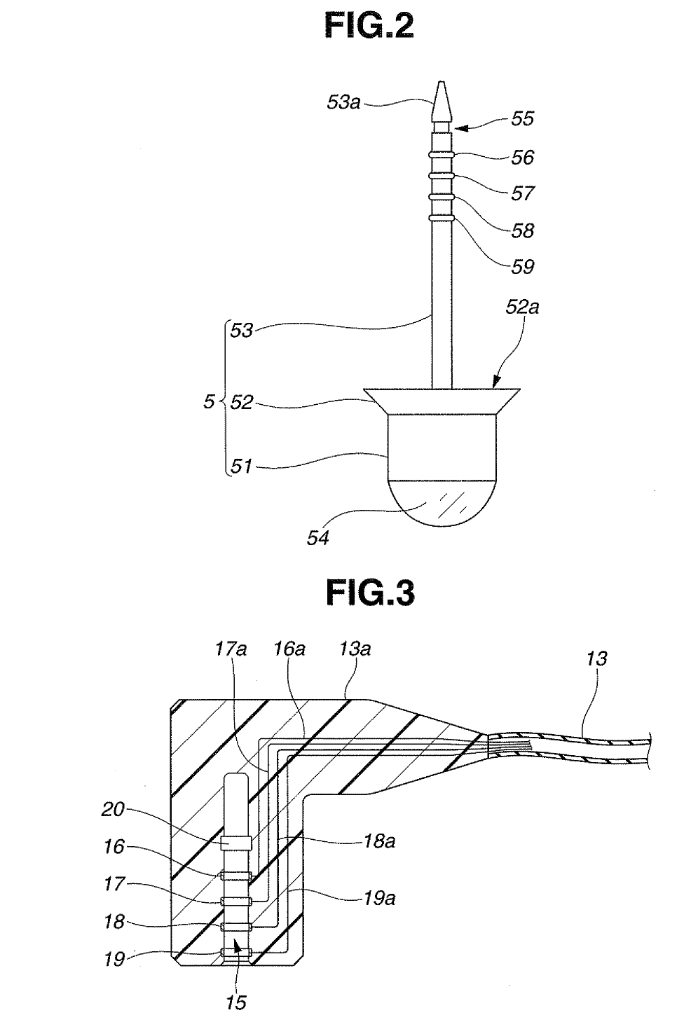

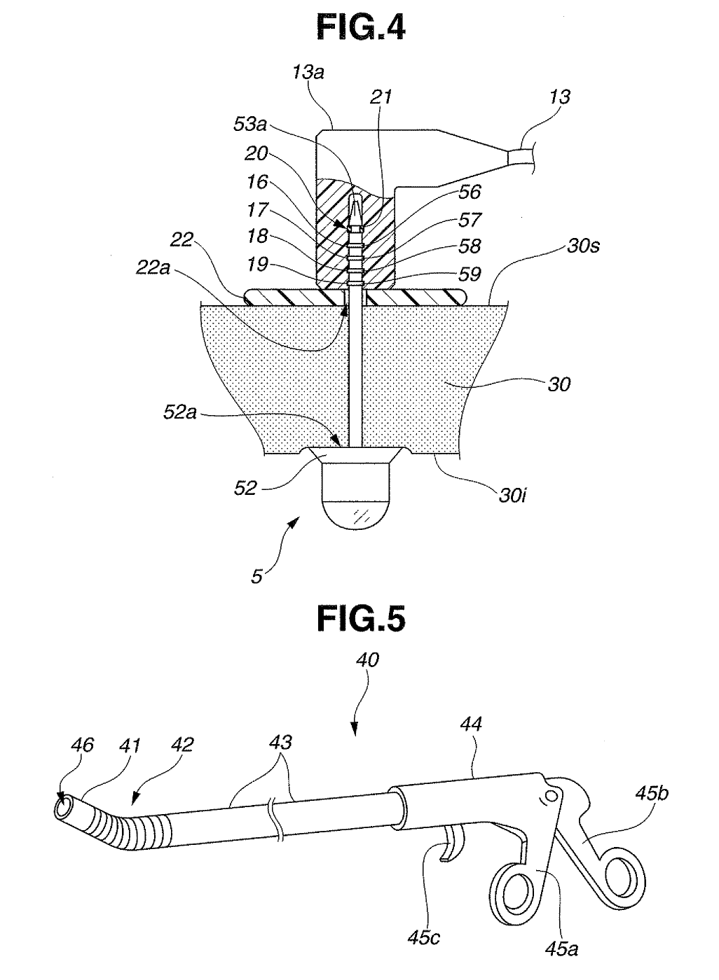

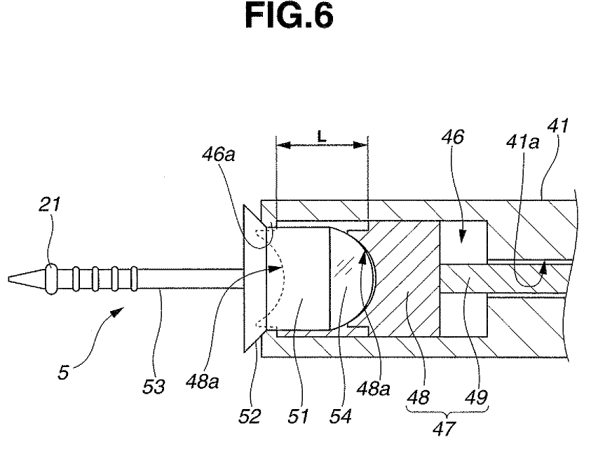

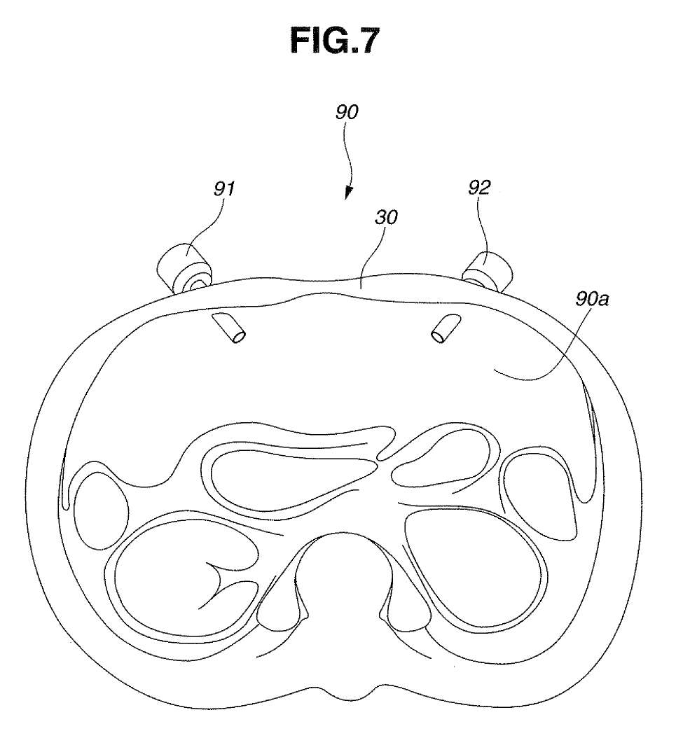

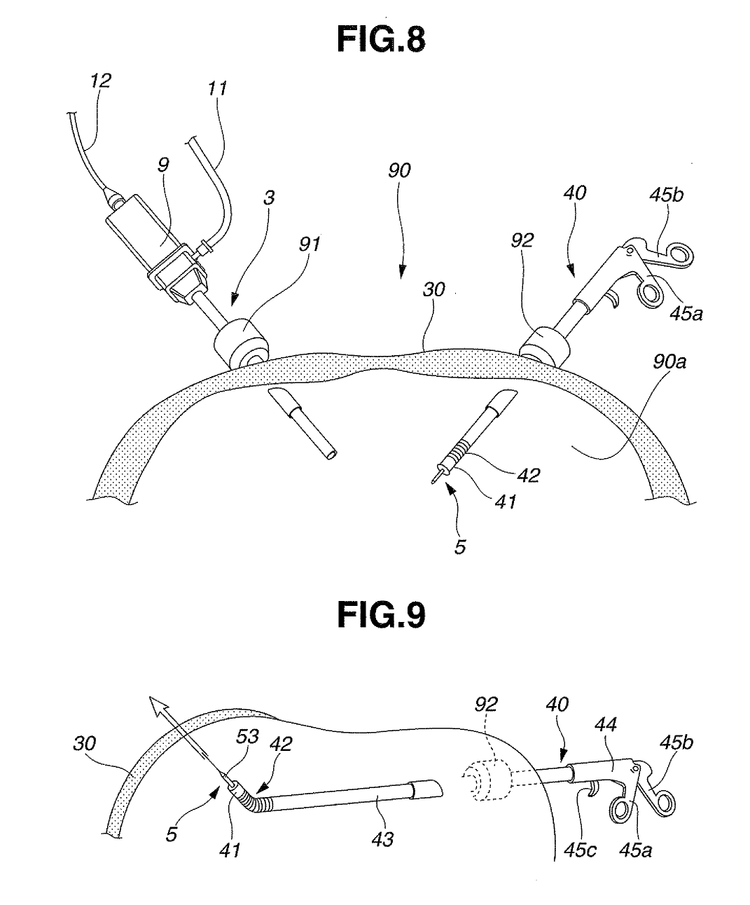

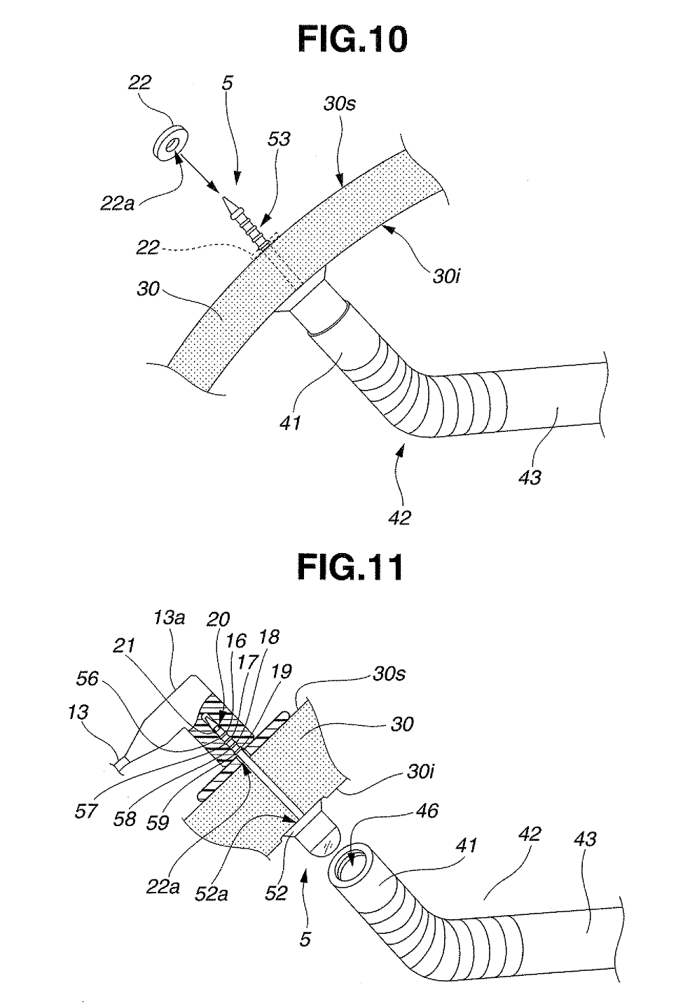

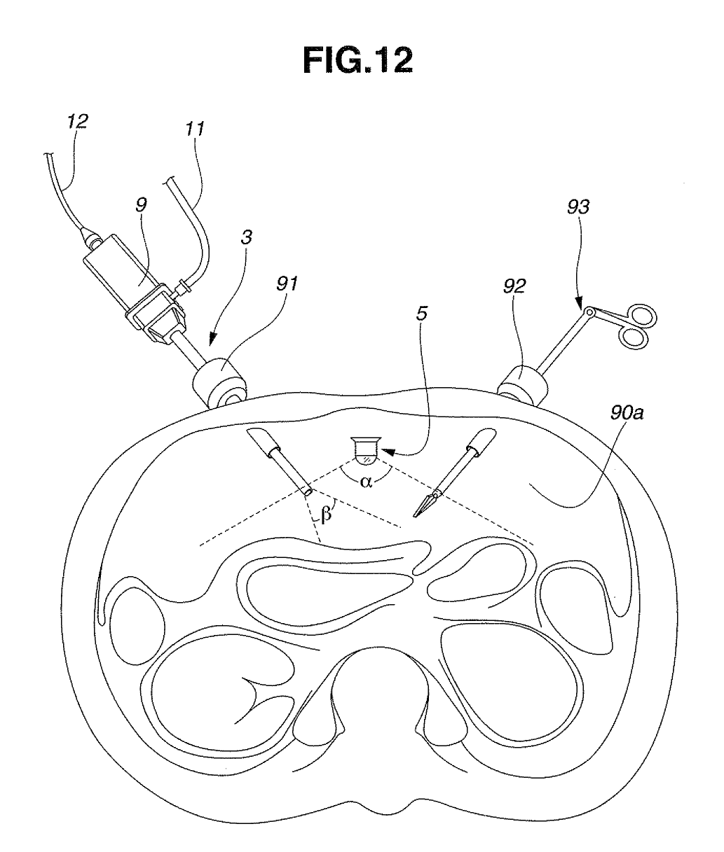

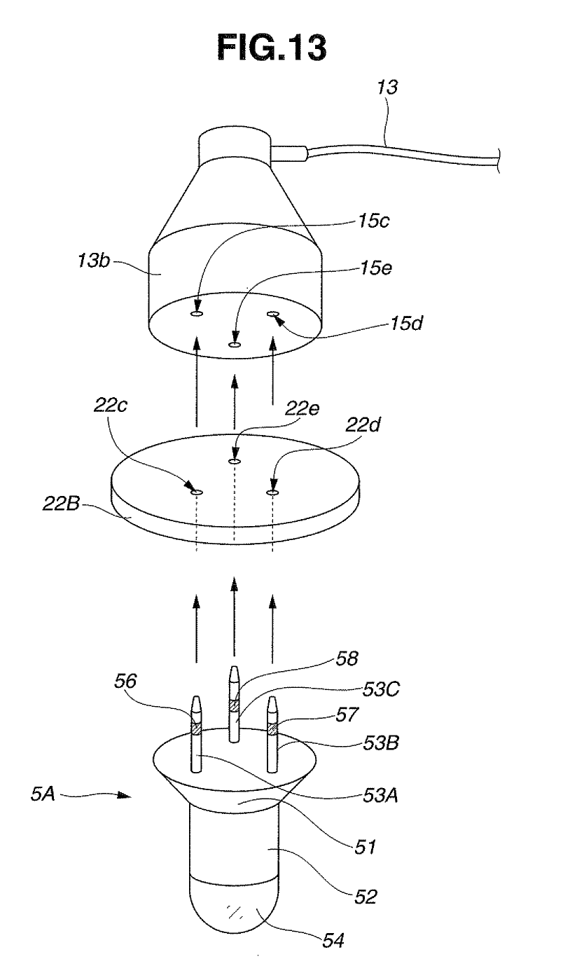

FIGS. 1 to 13 relate to a first embodiment of an endoscope system. FIG. 1 is a diagram showing an endoscope system; FIG. 2 is a diagram showing a camera set on body cavity inner wall; FIG. 3 is a sectional view of the configuration of a camera cable; FIG. 4 is a diagram showing a state in which the camera set on body cavity inner wall is set on a body cavity wall; FIG. 5 is a diagram showing a camera attachment/detachment forceps; FIG. 6 is a diagram showing the configuration of a distal end portion of the camera attachment/detachment forceps and the function of a camera receiving portion provided in the distal end portion; FIG. 7 is a diagram showing an abdominal wall pierced with trocars; FIG. 8 is a diagram showing a state in which, to retain the camera on an abdominal wall, a rigid endoscope is inserted in one trocar while the camera attachment/detachment forceps having the camera body placed in the camera receiving portion is inserted in the other trocar; FIG. 9 is a diagram showing a state in which a needle portion of the camera is opposed to an inner surface of an abdominal wall by operating the camera attachment/detachment forceps; FIG. 10 is a diagram showing a state in which the abdominal wall is punctured with the needle portion of the camera from the inner surface side of the abdominal wall, and in which the needle portion projects from the outer surface of the abdominal wall; FIG. 11 is a diagram showing a state in which a camera-side connector is attached to the needle portion projecting from the outer surface of the abdominal wall; FIG. 12 is a diagram showing a state in which an operation is performed by inserting the rigid endoscope in one trocar and by inserting a grasping forceps in the other trocar; and FIG. 13 is a diagram showing a camera of a different configuration having three needle portions, a stopper disk of a different configuration corresponding to the camera and a camera side connector of a different configuration corresponding to the camera.

FIG. 1 shows an endoscope system 1 for performing surgical operations. The endoscope system 1 has, as its main components, a light source device 2, a rigid endoscope 3, a first camera control unit (hereinafter referred to as “CCU”) 4, which is a first display control unit, a camera set on body cavity inner wall (hereinafter referred to briefly as “camera”) 5, which is set in a body cavity wall, and which is an image pickup unit configuring an image pickup means, a CCU 6, which is a second display control unit, a first display device 7, and a second display device 8.

The light source device 2 supplies illumination light to an illumination optical system provided in the rigid endoscope 3. The light source device 2 and the rigid endoscope 3 are detachably connected to each other through a light source cable 11. The rigid endoscope 3 has an ocular portion in its proximal end portion. A rigid endoscope camera 9 is attached to the ocular portion. An optical image of an observed portion illuminated with illumination light supplied from the light source device 2 to the rigid endoscope 3 is picked up with the rigid endoscope camera 9 attached to the ocular portion. The rigid endoscope camera 9 photoelectrically converts the picked-up optical image into an image pickup signal and transmits the image pickup signal to the first CCU 4 via an image pickup cable 12. The first CCU 4 produces a video signal from the transmitted image pickup signal and outputs the video signal to the first display device 7. The first display device 7 is, for example, a liquid crystal display. The first display device 7 receives the video signal outputted from the first CCU 4 and displays the endoscopic image of the observed portion on the screen.

As shown in FIGS. 1 and 2, the camera 5 has a camera body 51, a base portion 52 and a needle portion 53. A semispherical transparent hood 54 is provided on the camera body 51. The camera body 51 includes an image pickup portion, an illumination portion, a control portion and a power supply portion (not shown). The image pickup portion incorporated in the camera body 51 is an image pickup device such as a CCD, a C-MOS or the like. The image pickup portion picks up an optical image of the observed portion illuminated with illumination light from the incorporated illumination portion. An image signal outputted from the image pickup portion is outputted to the outside via a transmitting/receiving portion.

The base portion 52 is a member in the form of a disk configured of an elastic member having biocompatibility. The base portion 52 has a holding surface 52a which is brought into abutment on a body cavity wall. The base portion 52 is formed so that its outside diameter is larger than that of the camera body 51.

The needle portion 53 is a puncturing portion configuring a puncturing means. For example, an abdominal cavity wall is punctured with the needle portion 53. The diameter of the needle portion 53 is about 3 mm. A distal end portion 53a of the needle portion 53 is formed into a pointed shape having a sharp point. A peripheral groove 55 configuring an engagement mechanism for preventing the camera 5 from coming off a camera-side connector described below (indicated by reference character 13a, hereinafter referred to briefly as “connector”) is formed in the needle portion 53 in the vicinity of the distal end portion. A member configuring a fixing mechanism, e.g., an O-ring (indicated by reference character 21 in FIGS. 4 and 6) is placed in the peripheral groove 55. The needle portion 53 is a hard member having an insulating property. On a side nearer to the proximal end side than the peripheral groove 55, electrodes, e.g., four electrodes 56, 57, 58, and 59 connected to the image pickup portion, the illumination portion, the control portion and the power supply portion, respectively, are provided.

In the present embodiment, an image signal outputted from the transmitting/receiving portion of the camera 5 is transmitted to the second CCU 6 via a signal wire inserted through a camera cable 13 in a state where the needle portion 53 of the camera 5 is connected to the connector 13a attached to a camera cable 13 shown in FIG. 1. The second CCU 6 produces a video signal from the transmitted image pickup signal and outputs the video signal to the second display device 8. The second display device 8 is also a liquid crystal display. The second display device 8 receives the video signal outputted from the second CCU 6 and displays the camera image on the screen.

Note that, reference character 14a in FIG. 1 denotes a first video cable, and reference character 14b denotes a second video cable. The first video cable 14a connects the first CCU 4 and the first display device 7 to each other, and the second video cable 14b connects the second CCU 6 and the second display device 8 to each other.

As shown in FIG. 3, the connector 13a provided on the camera cable 13 is formed of a resin member having an insulating property. A coupling hole 15 is formed in the connector 13a. In the coupling hole 15, electric contacts 16, 17, 18, and 19 respectively corresponding to the electrodes 56, 57, 58, and 59 provided on the needle portion 53 are provided. In the coupling hole 15, a fixing groove 20 which constitutes the fixing mechanism and in which the above-described O-ring is placed is also provided. One ends of signal wires 16a, 17a, 18a, and 19a are respectively connected to the electric contacts 16, 17, 18, and 19. The other ends of the signal wires 16a, 17a, 18a, and 19a are inserted through the camera cable 13 and extended into CCU-side connectors connected to the second CCU 6. That is, the coupling hole 15 serves both as an electrical connection portion and as a mechanical connection portion.

As shown in FIG. 4, the camera 5 is set (retained), for example, on an inner surface 30i of an abdominal wall 30. In this set state, a stopper disk 22, which is a stopper member, is placed between the connector 13a and a surface 30s of the abdominal wall 30. In the state where the stopper disk 22 is placed, the O-ring 21 placed in the peripheral groove 55 of the needle portion 53 is placed by being press-fitted in the fixing groove 20 in the coupling hole 15. Thereby the holding surface 52a of the base portion 52 is brought into abutment on the inner surface 30i of the abdominal wall 30 to adhere to the same. Also in the set state, the electrode 56 and the electric contact 16, the electrode 57 and the electric contact 17, the electrode 58 and the electric contact 18, and the electrode 59 and the electric contact 19 are electrically connected to each other. The stopper disk 22 is configured of an elastic member having biocompatibility. It is preferable that the stopper disk 22 has an electrical insulating property.

The camera 5 is set, for example, on the inner surface 30i of the abdominal wall 30 with a camera attachment/detachment forceps (hereinafter referred to briefly as “attachment/detachment forceps”) 40 shown in FIGS. 5 and 6.

As shown in FIG. 5, the attachment/detachment forceps 40 is constituted by a distal end portion 41, a bending portion 42, a shaft portion 43 and an operation portion 44 successively disposed in this order from the distal end side. The operation portion 44 is provided with a pair of bending handles 45a and 45b for operating and bending the bending portion 42, and a puncture lever 45c. The bending handle 45a is a fixed handle provided integrally with the operation portion 44. The bending handle 45b is a turnable handle turnably supported axially on the operation portion 44. The puncture lever 45c is turnable with respect to the operation portion 44 operated when a body wall is punctured with the camera 5. A forcing-out head (indicated by reference character 48 in FIG. 6) described below is moved toward the distal end by operating the puncture lever 45c. The shaft portion 43 is a rigid tubular member made of stainless steel for example. The bending portion 42 is constructed so as to be capable of being bent upward/downward direction as viewed in the figure. The distal end portion 41 is provided with a camera receiving portion 46, which is a recessed portion in which the camera 5 is placed.

As shown in FIG. 6, a through hole 41a communicating with the camera receiving portion 46 is formed in the distal end portion 41. A projecting portion 46a projecting toward a center axis direction of the camera receiving portion 46 is provided at a distal end opening of the camera receiving portion 46. The projecting portion 46a serves as a pressing portion for pressing a slanting surface of the base portion 52 when a body wall is punctured with the camera 5, as a coming-off preventing portion for preventing the forcing-out head 48 from coming off from the camera receiving portion 46, and as a grasping portion for grasping the camera body 51 by pressing an outer peripheral surface of the camera body 51.

The forcing-out head 48 configuring a puncture device 47 is slidably disposed in the camera receiving portion 46. The puncture device 47 is constructed by being provided with the forcing-out head 48 and a forcing-out shaft portion 49. A recessed head placement portion 48a is provided in a distal end portion of the forcing-out head 48. The transparent hood 54 of the camera body 51 configuring the camera 5 is placed in the head placement portion 48a.

The forcing-out shaft portion 49 is a wire member having flexibility. A distal end of the forcing-out shaft portion 49 is fixed to the head holding portion 48a, for example, by soldering. The forcing-out shaft portion 49 is extended into the operation portion 44 via the interior of the through hole 41a of the distal end portion 41, the interior of the bending portion 42 and the interior of the shaft portion 43. A proximal end of the forcing-out shaft portion 49 is fixed to the puncture lever 45c. Therefore, when the puncture lever 45c is operated to the bending handle 45a/45b side, the forcing-out shaft portion 49 is moved toward the distal end. Thereby the forcing-out head 48 is moved by a distance L toward the distal end, as indicated by the broken line.

The forcing-out head 48 is forwardly and backwardly movable in the camera receiving portion 46, but the movement of the forcing-out head 48 is limited such that the forcing-out head 48 does not move forward beyond the projecting portion 46a.

The procedure of setting the camera 5 on the inner surface 30i of the abdominal wall 30 will be described with reference to FIGS. 7 to 12.

An operator first prepares the camera 5, the attachment/detachment forceps 40, the stopper disk 22 and the camera cable 13 with the connector 13a for setting of the camera 5 on the inner surface 30i of the abdominal wall 30. The operator places the camera 5 in advance in the camera receiving portion 46 of the attachment/detachment forceps 40.

For example, as shown in FIG. 7, an abdominal portion of a patient 90 is pieced in advance at predetermined positions with two trocars 91 and 92 having insertion holes for introducing the rigid endoscope 3 and a surgical instrument or the like into an abdominal cavity 90a. The rigid endoscope 3 is inserted through the trocar 91, while a surgical instrument such as a grasping forceps or the attachment/detachment forceps 40 is inserted through the trocar 92. For example, one end portion of a pneumoperitoneum tube (not shown) is attached to the trocar 91. Also, a gas for pneumoperitoneum, e.g., carbon dioxide gas is introduced into the abdominal cavity 90a for the purpose of maintaining the field of view of the rigid endoscope 3 and maintaining a region for operating a surgical instrument or the like.

As shown in FIG. 8, the operator inserts the rigid endoscope 3 through the trocar 91 and inserts the attachment/detachment forceps 40 having the camera 5 placed in the camera receiving portion 46 in the distal end portion 41 through the trocar 92.

Subsequently, the operator bends the bending portion 42 as shown in FIG. 9 by operating the bending handle 45b of the attachment/detachment forceps 40 while checking an endoscopic image displayed on the screen of the first display device 7, thereby setting the puncture direction of the needle portion 53 of the camera 5 generally perpendicularly to the abdominal wall 30, as indicated by the arrow.

Subsequently, the operator brings the distal end portion 53a of the needle portion 53 of the camera 5 closer to the inner surface 30i of the abdominal wall 30 by manually operating the operation portion 44 of the attachment/detachment forceps 40. In this operation, the operator checks the endoscopic image displayed on the screen of the first display device 7, thereafter positions the distal end of the needle portion 53 by setting the distal end to the abdominal wall 30, and operates the puncture lever 45c.

The needle portion 53 then projects out of a surface 30s of the abdominal wall 30. That is, the needle portion 53 is passed through the abdominal wall 30 from the inner surface 30i to the surface 30s. The operator sets the stopper disk 22 by passing the needle portion 53 projecting from the surface 30s of the abdominal wall 30 through a through hole 22a of the stopper disk 22, thereby placing the stopper disk 22 on the surface of the abdominal wall.

Thereafter, the operator couples the projecting needle portion 53 and the connector 13a to each other. That is, the operator inserts the needle portion 53 in the coupling hole 15 provided in the connector 13a. The O-ring 21 placed in the peripheral groove 55 of the needle portion 53 is then press-fitted and placed in the fixing groove 20 in the coupling hole 15, as shown in FIG. 11. As a result, one surface of the stopper disk 22 adheres to the surface 30s of the abdominal wall 30, and the holding surface 52a of the base portion 52 of the camera 5 also adheres to the inner surface of the abdominal wall 30, with the abdominal wall 30 pinched between the camera 5 and the stopper disk 22. At this time, the electrode 56 and the electric contact 16, the electrode 57 and the electric contact 17, the electrode 58 and the electric contact 18, and the electrode 59 and the electric contact 19 are respectively connected electrically to each other.

The operator checks the setting of the camera 5 on the inner surface 30i of the abdominal wall 30 through the endoscopic image displayed on the screen of the first display device 7, and thereafter turns on the camera 5 by operating the second CCU 6. A camera image picked up with the camera 5 is then displayed on the screen of the second display device 8. Thereafter, the operator draws the attachment/detachment forceps 40 out of the trocar 92, inserts, for example, the grasping forceps 93 in the trocar 92 as shown in FIG. 12, and performs an operation.

The operator performs the operation while checking the endoscopic image in an image pickup range β of the rigid endoscope 3 displayed on the screen of the first display device 7 and the camera image in an image pickup range a of the camera 5C displayed on the screen of the second display device 8.

After the completion of the operation, the operator detaches the connector 13a from the needle portion 53. The camera 5 is then left in a state of being attached to the inner surface 30i of the abdominal wall 30. The operator detaches the camera 5 from the abdominal wall 30 by operating the grasping forceps 93 while observing the endoscopic image displayed on the screen of the first display device 7, and thereafter draws the camera 5 out of the body cavity.

As described above, a needle portion is provided on a camera and a body wall is punctured with the needle portion of the camera, thus enabling setting of the camera capable of obtaining an image of a wider field of view in comparison with an endoscopic image without impairing reduced invasiveness. This camera setting enables the operator to perform a surgical operation by visually checking both the endoscopic image and the camera image.

When the camera is set on the inner surface of the body wall, the attachment/detachment forceps having the camera receiving portion in which the transparent hood provided on the camera body is placed is used. This attachment/detachment forceps is drawn out of the body cavity after performing the operation to puncture the body wall with the needle portion of the camera and the operation to set the camera on the inner surface of the body wall in the state where the transparent hood of the camera body is placed in the camera receiving portion, thus enabling prevention of a fault due to attachment of blood, a body fluid or the like to the transparent hood during the operation for setting the camera in the body wall.

While the camera 5 is provided with the needle portion 53 in the present embodiment, a camera 5A may be constructed by providing a needle portion 53A having an electrode 56, a needle portion 53B having an electrode 57 and a needle portion 53C having an electrode 58 as shown in FIG. 13. In a stopper disk 22B adapted to this camera 5A, a plurality of through holes 22c, 22d, and 22e respectively corresponding to the needle portions 53A, 531B, and 53C are formed. Also, a plurality of coupling holes 15c, 15d, and 15e having electric contacts (not shown) respectively corresponding to the electrodes 56, 57, and 58 are provided in a connector 13b.

In the present embodiment, a body wall is punctured with the camera 5 by using the attachment/detachment forceps 40. However, a body wall may be punctured with the camera by using a surgical instrument such as a grasping forceps or the like without using the attachment/detachment forceps 40.

While in the above-described embodiment a signal is transmitted by means of the camera cable 13 extending from the connector 13a or 13b, wireless signal transmission may alternatively be performed. That is, antennas for communication may be provided on the connector 13a or 13b and the second CCU 6.

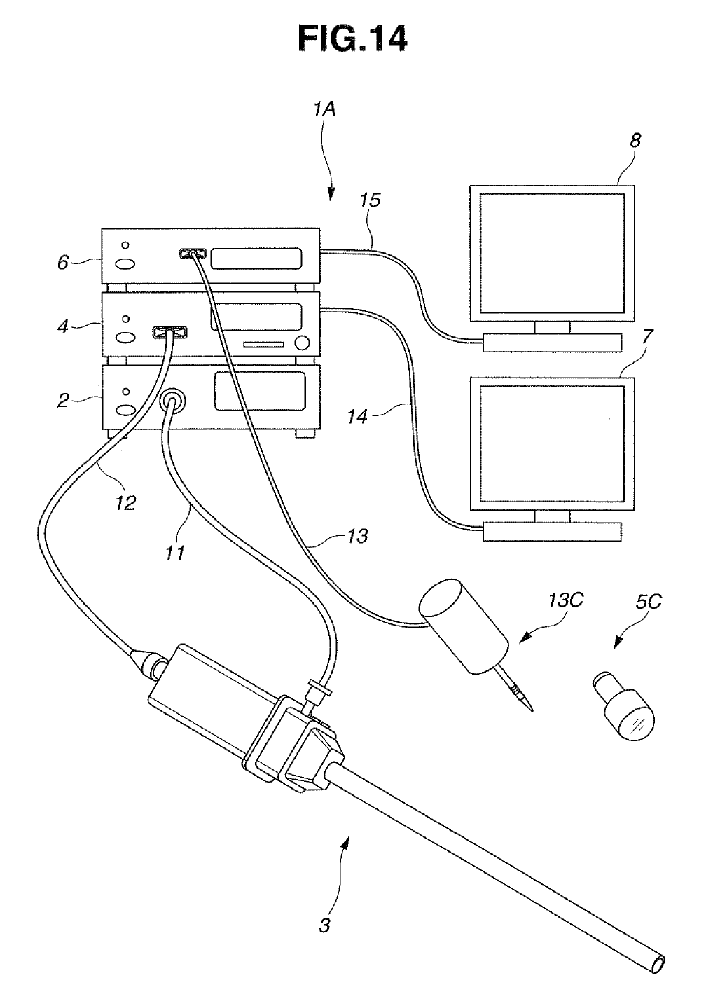

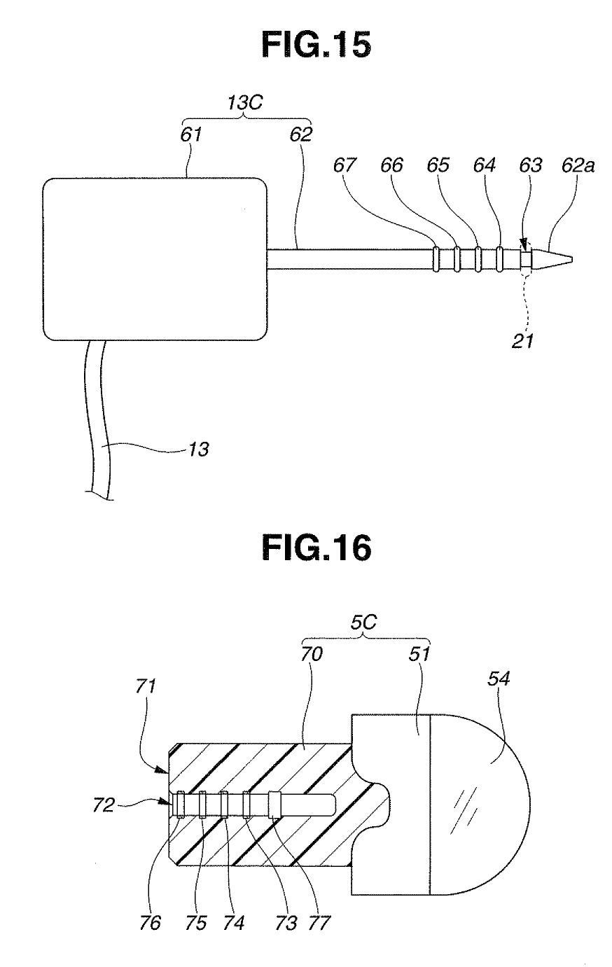

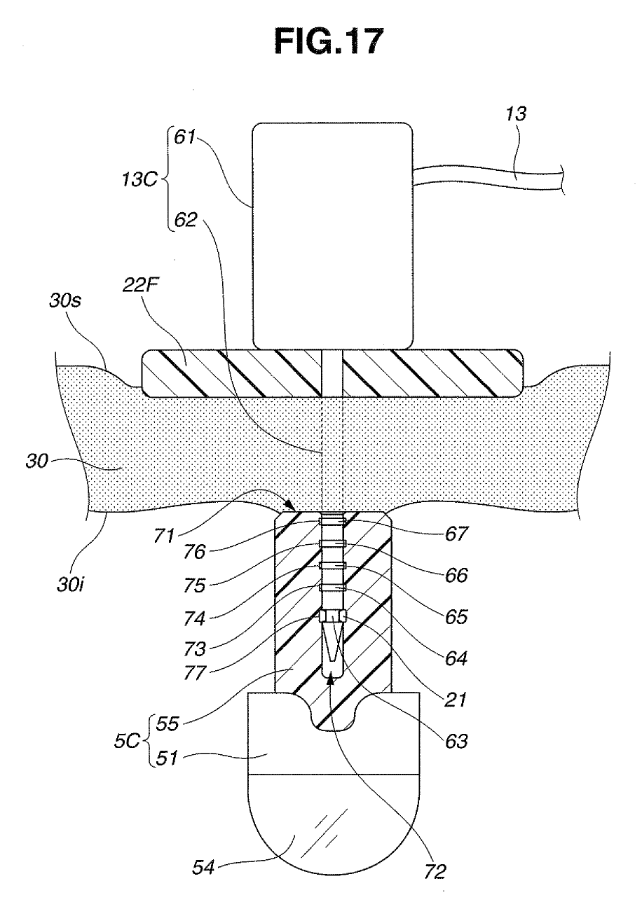

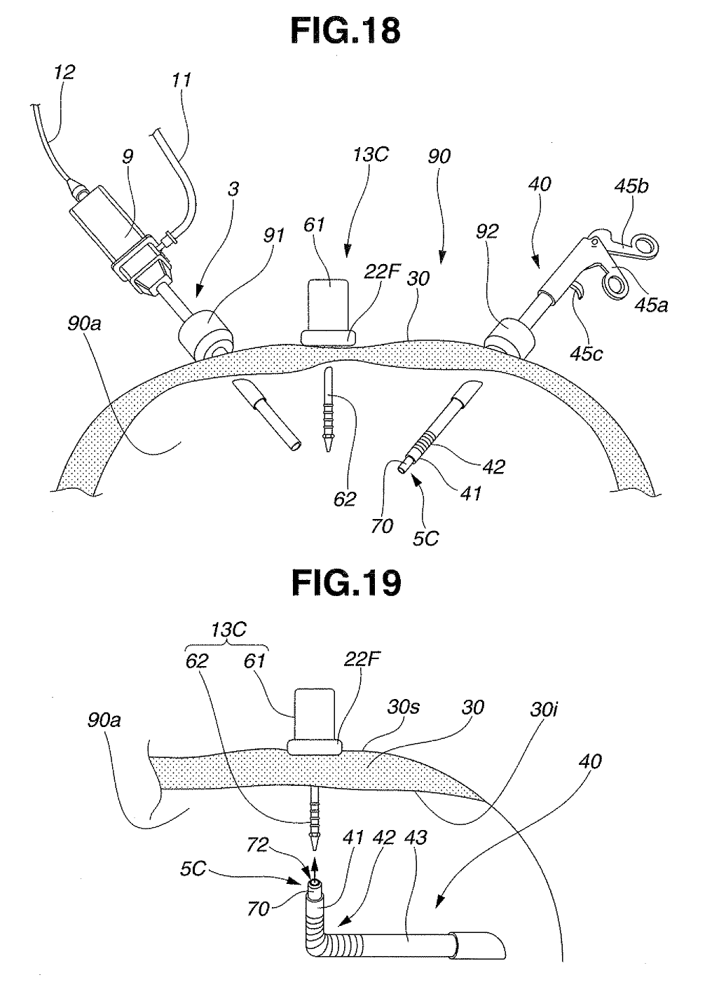

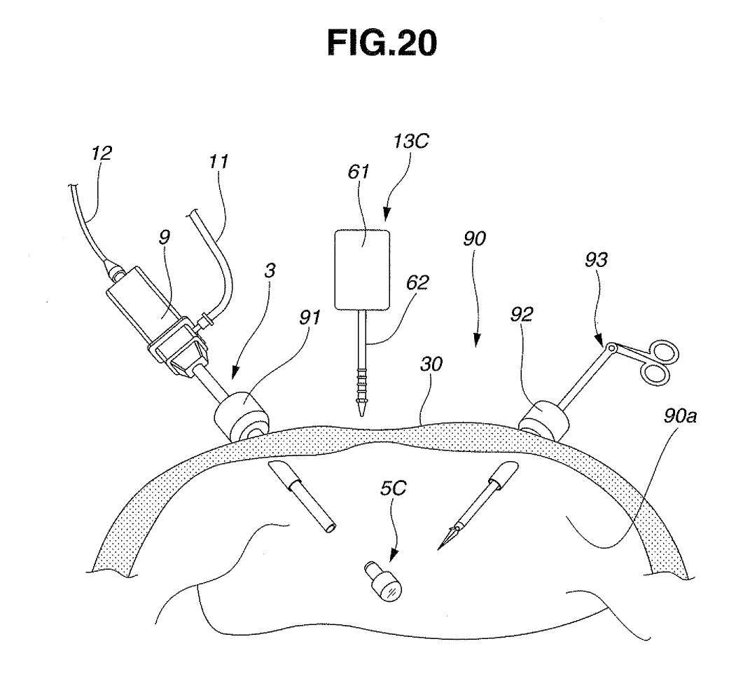

FIGS. 14 to 20 relate to a second embodiment of the endoscope system. FIG. 14 is a diagram showing an endoscope system according to the second embodiment; FIG. 15 is a diagram showing the configuration of a camera cable; FIG. 16 is a partially sectional view showing a camera set on body cavity inner wall; FIG. 17 is a diagram showing a state in which the camera set on body cavity inner wall is set on a body cavity wall; FIG. 18 is a diagram showing a state in which an abdominal wall is punctured from an outer surface of an abdominal wall to the interior of an abdominal cavity with a needle portion provided at one end of the camera cable in a state in which, to retain the camera on the abdominal wall, a rigid endoscope is inserted in one trocar while a camera attachment/detachment forceps having the camera body placed in a camera receiving portion is inserted in the other trocar; FIG. 19 is a diagram showing a state in which the camera is attached to the needle portion with which the abdominal wall is punctured; and FIG. 20 is a diagram showing a state in which the needle portion provided at one end of the camera cable is drawn out of the abdominal wall and the camera is detached in the abdominal wall.

An endoscope system 1A in the present embodiment for performing a surgical operation, shown in FIG. 14, differs from the endoscope system 1 in the first embodiment in the configuration of a camera 5C and a connector 13C. In other respects, the configuration of the endoscope system 1A is the same as that in the first embodiment. Components identical to those in the first embodiment are indicated by the same reference characters and the description thereof will be omitted.

As shown in FIGS. 14 and 15, the connector 13C is provided on a distal end of a camera cable 13. The connector 13C is constituted by a connector body 61 and a needle portion 62.

The needle portion 62 is a puncturing portion configuring a puncturing means. For example, an abdominal cavity wall is punctured with the needle portion 62. The diameter of the needle portion 62 is about 3 mm. A distal end portion 62a of the needle portion 62 is formed into a shape having a sharp point. A peripheral groove 63 configuring an engagement mechanism for preventing the camera 5 from coming off is formed in the vicinity of the distal end portion of the needle portion 62. An O-ring 21 configuring a fixing mechanism is placed in the peripheral groove 63. On the proximal end side of the peripheral groove 63 on the needle portion 62, electrodes 64, 65, 66, and 67 are provided. One ends of the signal wires 16a, 17a, 18a, and 19a are respectively connected to the electrodes 64, 65, 66, and 67. Also, the other ends of the signal wires 16a, 17a, 15a, and 19a are inserted through the camera cable 13 and extend into CCU-side connectors connected to the second CCU 6. The connector body 61 and the needle portion 62 of the connector 13C provided on the camera cable 13 are formed of rigid members having an insulating property.

As shown in FIGS. 14 and 16, the camera 5C has a camera body 51 and a connection portion 70. A transparent hood 54 is provided on the camera body 51. The connection portion 70 is a cylindrical insulating member formed to have smaller diameter than the outside diameter of the camera body 51. An end surface 71 of the connection portion 70 is an abutment surface to be brought into abutment on a body cavity wall. A coupling hole 72 having an opening in this abutment surface is provided. In the coupling hole 72, electric contacts 73, 74, 75, and 76 to be electrically connected to the electrodes 64, 65, 66, and 67 provided on the needle portion 62 of the connector 13C and a fixing groove 77 configuring a fixing mechanism are provided.

That is, the coupling hole 72 serves both as an electrical connection portion and as a mechanical connection portion.

In the present embodiment, an image signal outputted from a transmitting/receiving portion of the camera 5C is transmitted to the second CCU 6 via a signal wire inserted through the camera cable 13 in a state where the camera 5C is connected to the needle portion 62 provided on the connector 13C of the camera cable 13 shown in FIG. 14.

As shown in FIG. 17, the camera 5C is set, for example, on an inner surface 30i of an abdominal wall 30. In this set state, a stopper disk 22F is placed between the connector body 61 of the connector 13C and a surface 30s of the abdominal wall 30. In the state where the stopper disk 22F is placed, the O-ring 21 placed in the peripheral groove 63 of the needle portion 62 is press-fitted and placed in the fixing groove 77 of the coupling hole 72. The end surface 71 of the connection portion 70 configuring the camera 5C is thereby brought into abutment on the inner surface 30i of the abdominal wall 30 to adhere to the same. Also in the set state, the electrode 64 and the electric contact 73, the electrode 65 and the electric contact 74, the electrode 66 and the electric contact 75, and the electrode 67 and the electric contact 76 are electrically connected to each other.

The camera 5C is set, for example, on the inner surface 30i of the abdominal wall 30 with a camera attachment/detachment forceps (hereinafter referred to briefly as “attachment/detachment forceps”) 40 shown in FIGS. 18 and 19.

The procedure of setting the camera 5C on the inner surface 30i of the abdominal wall 30 will be described with reference to FIGS. 18 and 19.

An operator first prepares the camera 5C, the attachment/detachment forceps 40, the stopper disk 22F and the camera cable 13 with the connector 13C for setting of the camera 5C on the inner surface 30i of the abdominal wall 30. The operator places the camera 5C in advance in the camera receiving portion 46 of the attachment/detachment forceps 40.

As shown in FIG. 18, an abdominal portion of a patient 90 is pierced in advance with trocars 91 and 92 at predetermined positions. Note that, the rigid endoscope 3 is inserted through the trocar 91, while the attachment/detachment forceps 40 is inserted through the trocar 92.

The operator inserts the rigid endoscope 3 through the trocar 91 and inserts the attachment/detachment forceps 40 having the camera 5C placed in the camera receiving portion 46 in the distal end portion 41 through the trocar 92. The operator then punctures an abdominal portion with the needle portion 62 of the connector 13C at a predetermined position.

Subsequently, the operator searches for the needle portion 62 projecting into the abdominal cavity 90a by checking the endoscopic image displayed on the screen of the first display device 7. After finding the needle portion 62 projecting from the inner surface 30i by piercing through the abdominal wall 30, the operator bends the bending portion 42 as shown in FIG. 19 by operating the bending handle 45b of the attachment/detachment forceps 40 in order to connect the camera 5C to the needle portion 62. The operator then brings the coupling hole 72 of the connection portion 70 configuring the camera 5C placed in the camera receiving portion 46 closer to the needle portion 62 projecting from the inner surface 30i of the abdominal wall 30, as indicated by the arrow.

Subsequently, the operator inserts the distal end portion 62a of the needle portion 62 in the coupling hole 72 of the connection portion 70 by visually checking the endoscopic image displayed on the screen of the first display device 7. Thereafter, the operator operates the puncture lever 45c.

The needle portion 62 projecting from the inner surface 30i of the abdominal wall 30 is then placed in the coupling hole 72 of the connection portion 70, as shown in FIG. 17. That is, the needle portion 62 of the connector 13C projecting and the connection portion 70 of the camera 5C are coupled to each other. The camera 5C is thereby placed on the abdominal wall 30, with the abdominal wall pinched between the camera 5C and the stopper disk 22F. At this time, the electrode 64 and the electric contact 73, the electrode 65 and the electric contact 74, the electrode 66 and the electric contact 75, and the electrode 67 and the electric contact 76 are respectively connected electrically to each other.

The operator checks the setting of the camera 5C on the inner surface 30i of the abdominal wall 30 through the endoscopic image displayed on the screen of the first display device 7, and thereafter turns on the camera 5C by operating the second CCU 6. A camera image picked up with the camera 5C is then displayed on the screen of the second display device 8. Thereafter, the operator draws the attachment/detachment forceps 40 out of the trocar 92, inserts, for example, the grasping forceps 93 in the trocar 92 as shown in FIG. 12, and performs an operation.

The operator performs the operation while checking the endoscopic image in an image pickup range β of the rigid endoscope 3 displayed on the screen of the first display device 7 and the camera image in an image pickup range α of the camera 5C displayed on the screen of the second display device 8.

After the completion of the operation, the operator detaches the needle portion 62 of the connector 13C from the abdominal wall. The camera 5C then falls in the abdominal cavity 90a, as shown in FIG. 20. The operator grasps the camera 5C fallen in the abdominal cavity 90a and takes the camera 5C out of the body cavity by operating the grasping forceps 93 or the attachment/detachment forceps while observing the endoscopic image displayed on the screen of the first display device 7.

As described above, a needle portion is provided on a connector, a body wall is punctured with the needle portion of the connector, and a camera is attached to the needle portion projecting into a body cavity, thus enabling setting of the camera capable of obtaining an image of a wider field of view in comparison with an endoscopic image without impairing reduced invasiveness. This camera setting enables the operator to perform a surgical operation by visually checking both the endoscopic image and the camera image.

Also in the present embodiment, the camera 5C may be attached to a body wall by using a surgical instrument such as a grasping forceps without using the attachment/detachment forceps 40. Also, while transmission of a signal by means of the camera cable 13 extending from the connector 13C, wireless signal transmission may alternatively be performed.

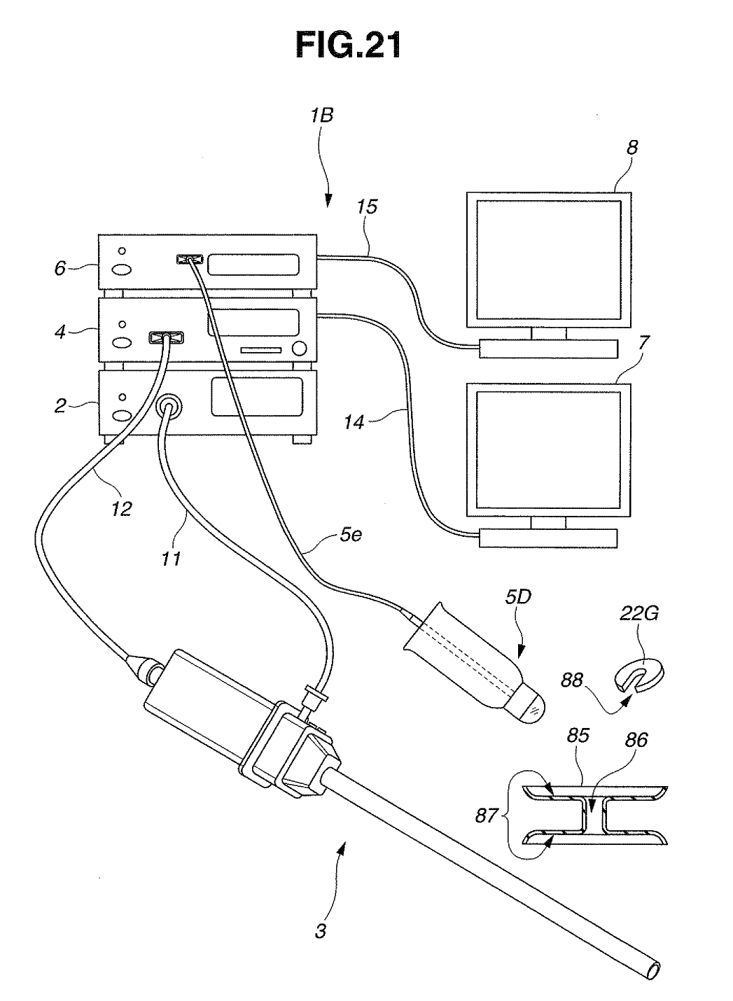

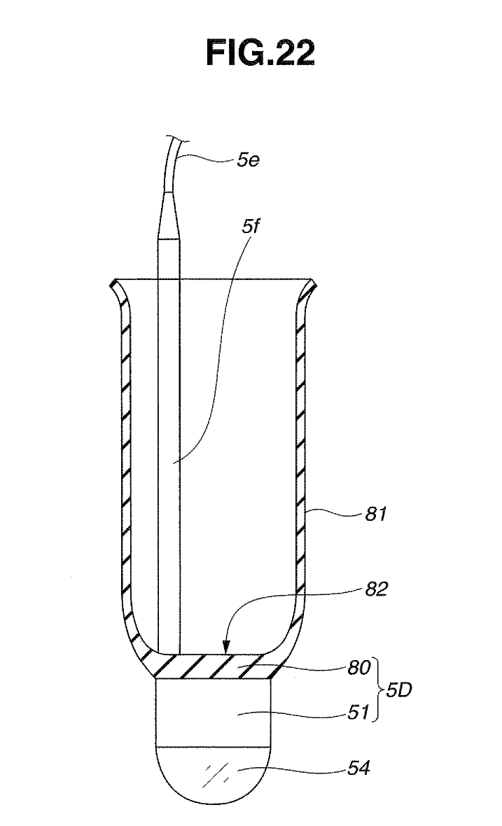

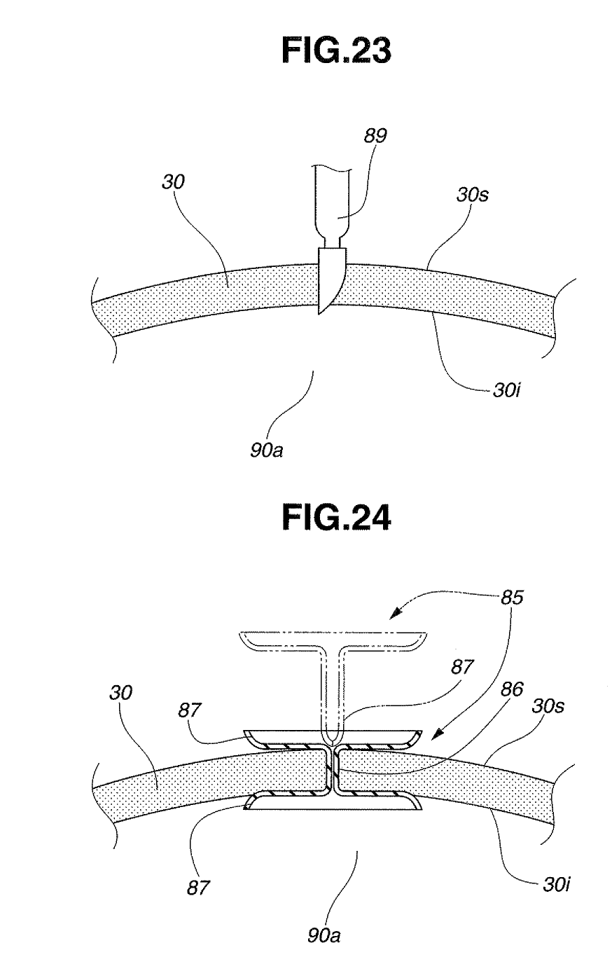

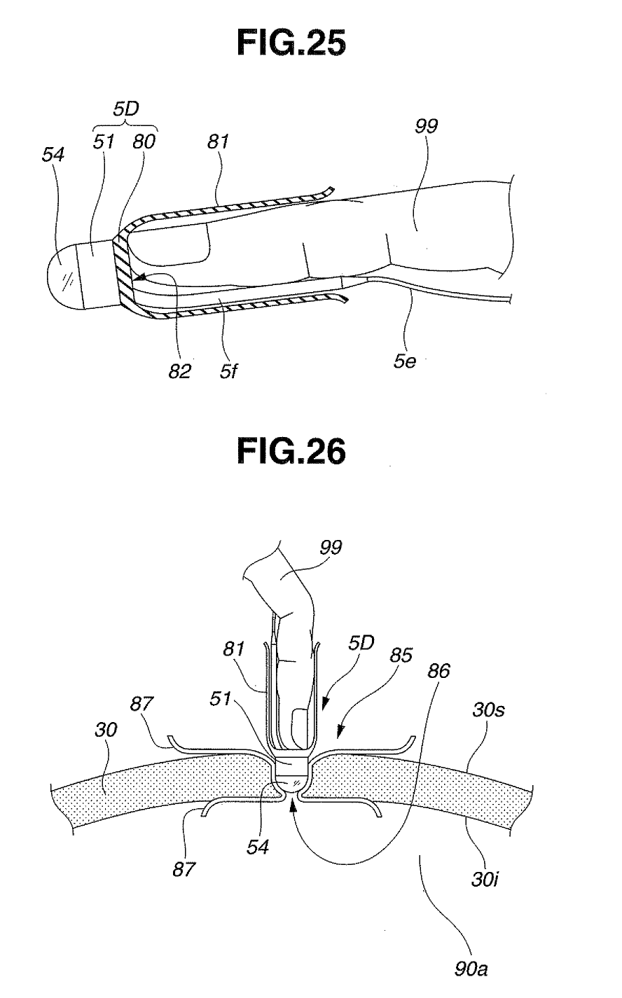

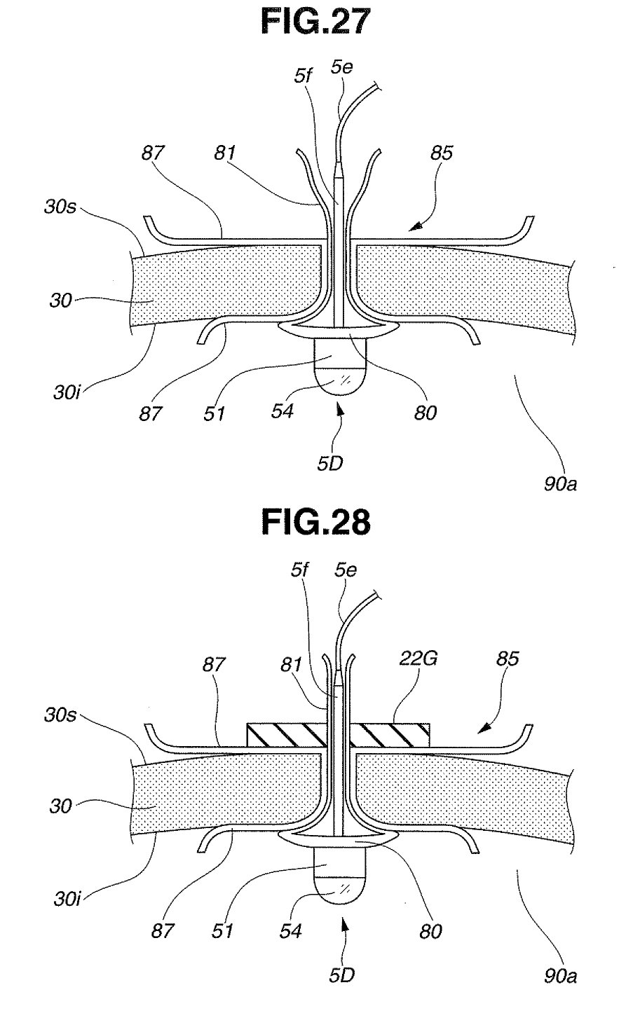

FIGS. 21 to 28 relate to a third embodiment of the endoscope system. FIG. 21 is a diagram showing an endoscope system in the third embodiment; FIG. 22 is a diagram showing a camera with a finger sack; FIG. 23 is a diagram showing forming of a small dissected portion on the abdominal wall with a surgical knife; FIG. 24 is a diagram showing a state in which an outer cover is placed by being forced into the small dissected portion; FIG. 25 is a diagram showing a state in which a finger is inserted in the finger sack of the camera; FIG. 26 is a diagram showing a state in which the camera is forced into an abdominal cavity through a center channel provided in the outer cover; FIG. 27 is a diagram showing a state in which the camera is inserted in the abdominal cavity; and FIG. 28 is a diagram showing a state in which the camera is set in the abdominal cavity.

An endoscope system 1B for performing a surgical operation, shown in FIG. 21, differs from the endoscope systems 1 and 1A in the above-described embodiments in the configuration of a camera 5D. In other respects, the configuration of the endoscope system 1B is the same as that in the above-described embodiments. Components identical to those in the above-described embodiments are indicated by the same reference characters and the description thereof will be omitted.

As shown in FIGS. 21 and 22, the camera 5D is configured by being provided with a camera body 51 and a base portion 80 with a finger sack portion 81 which is a cover portion in the form of a sack. The base portion 80 is formed to have a diameter larger than the outside diameter of the camera body 51. A finger tip of an operator is inserted in the finger sack portion 81. A transparent hood 54 is provided on the camera body 51. The base portion 80 is formed of an elastic member having biocompatibility.

A camera cable 5e extends from a proximal end surface 82 of the camera body 51. A cable end portion 5f of the camera cable 5e positioned in the finger sack portion 81 is configured to have a large diameter for the purpose of protecting a signal wire. The cable end portion 5f of the camera cable 5e is provided on the proximal end surface outer peripheral side of the camera body 51 to prevent breakage of the signal wire when a finger is inserted in the finger sack portion 81 to bend the cable end portion 5f. The proximal end surface 82 of the camera body 51 has a pressing-surface function when the camera 5D is placed by being forced into a body cavity.

Reference character 85 in FIG. 21 denotes an outer cover and reference character 22G denotes a stopper disk. A cut 88 of a width size considering the diameter of the cable end portion 5f is formed in the stopper disk 22G. The outer cover 85 has a central channel forming portion (hereinafter referred to briefly as “channel”) 86 and a pair of disk-like portions 87 and is formed of an elastic member having biocompatibility. The disk-like portions 87 are formed by providing a bending habit portion so as to be deformed from a generally tubular shape into a disk shape.

In the present embodiment, an image signal outputted from a transmitting/receiving portion of the camera 5D is transmitted to the second CCU 6 via the signal wire inserted through the camera cable 5e.

The procedure of setting the camera SD on an inner surface 30i of an abdominal wall 30 will be described with reference to FIGS. 23 to 28.

In the present embodiment, the camera 5D is set on the inner surface 30i of the abdominal wall 30 by the fingers of the operator.

An operator first prepares the camera 5D, the outer cover 85, the stopper disk 22F and a surgical knife described below for setting of the camera 5D on the inner surface 30i of the abdominal wall 30. An abdominal portion of a patient 90 is pierced with a plurality of trocars (not shown), and the rigid endoscope 3 is inserted through at least one of the trocars.

As shown in FIG. 23, the operator forms, with a surgical knife 89, a small dissected portion communicating between the inner surface 30i and the surface 30s of the abdominal wall 30 at a desired position on the abdominal wall 30.

Next, the operator forces one of the disk-like portions 87 of the outer cover 85 into the small dissected portion. In this operation, the disk-like portion 87 on the forced-in side is deformed into a generally tubular shape against the elastic force, as indicated by the double-dot-dash line shown in FIG. 24. The disk-like portion 87 deformed into the tubular shape is forced into the small dissected portion. When doing this, the operator introduces the disk-like portion 87 into the abdominal cavity while observing an endoscopic image displayed on the screen of the first display device 7.

The operator checks through the endoscopic image on the first display device 7 whether or not the one disk-like portion 87 has been introduced into the abdominal cavity. If necessary, the operator extends the disk-like portion 87 having the tubular shape into the disk-like shape by suitably operating the disk-like portion 87 with a grasping forceps introduced into the abdominal cavity through a trocar (not shown). The outer cover 85 is thereby placed on the abdominal wall 30, with the pair of disk-like portions 87 of the outer cover 85 extended in disk form on the surface 30s side and the inner surface 30i side of the abdominal wall 30, as indicated by the solid line in FIG. 24.

Subsequently, as shown in FIG. 25, the operator places his/her finger 99 in the finger sack portion 81 provided on the camera 5D in order to introduce the body 51 of the camera 5D into the abdominal cavity 90a through the channel 86 of the outer cover 85 placed in the abdominal wall 30. The camera 5D is thereby attached to the operator's finger by the elastic force of the finger sack portion 81.

In this state, the operator introduces the camera 5D into the abdominal cavity 90a, as shown in FIG. 26. More specifically, the operator forces the camera body 51 into the abdominal cavity 90a direction, guided by the transparent hood 54 of the camera 5D, while extending, by a finger operation, the channel 86 in the closed state from the disk-like portion 87 placed on the surface 30s side of the abdominal wall 30. During this operation, the transparent hood 54 is forced forward along the channel 86, thus preventing the surface of the transparent hood 54 from being contaminated with a body fluid or the like. After forcing the camera body 51 into the abdominal cavity 90a, the operator removes the finger 99 out of the finger sack portion 81. The camera body 51 is thereby retained in the abdominal cavity 90a.

Subsequently, the operator turns on the camera 5D by operating the second CCU 6. The operator then performs position adjustment so that the camera body 51 faces inside of the body cavity as shown in FIG. 27, by checking the endoscopic image displayed on the screen of the first display device 7 and a camera image picked up with the camera 5D and displayed on the screen of the second display device 8. At this time, the operator performs a manual operation such as an operation to pull the finger sack portion 81, the outer cover 85 or the cable end portion 5f to cause the proximal end surface 82 of the base portion 80 configuring the camera 5D to temporarily abut on the inner surface 30i of the abdominal wall 30.

Thereafter, the operator places the cut 88 in the stopper disk 22G at the cable end portion 5f pierced through the abdominal wall 30. The camera 5D is thus placed on the inner surface 30i of the abdominal wall 30, as shown in FIG. 28. At this time, an end portion of the finger sack portion 81 projects generally in O-ring form in the vicinity of the base portion 80 to adhere to the inner surface 30i of the abdominal wall 30 through the disk-like portion 87.

That is, the camera 5D is placed in a state where one surface of the stopper disk 22G adheres to the surface 30s of the abdominal wall 30, while an end portion of the base portion 80 of the camera 5D and an end portion of the finger sack portion 81 adhere to the inner surface 30i of the abdominal wall 30, with the abdominal wall 30 pinched between the camera 5D and the stopper disk 220.

Thereafter, the operator inserts, for example, the grasping forceps 93 in the trocar 92 as shown in FIG. 12 and performs an operation. The operator performs the operation while checking the endoscopic image in an image pickup range β of the rigid endoscope 3 displayed on the screen of the first display device 7 and the camera image in an image pickup range α of the camera 5D displayed on the screen of the second display device 8.

After the completion of the operation, the operator removes, by a finger operation, the camera 5D and the outer cover 85 retained in the abdominal cavity.

As described above, a finger sack portion is provided on a base portion configuring a camera, and an outer cover with a channel, which is formed of an elastic member, is placed in a small dissected portion formed in an abdominal wall, thus enabling setting of the camera capable of obtaining an image of a wider field of view in comparison with an endoscopic image without impairing reduced invasiveness. This camera setting enables the operator to perform a surgical operation by visually checking both the endoscopic image and the camera image.

In each of the configurations of the endoscope systems described above, the image pickup unit provided as an image pickup means for picking up an image in a body cavity is placed in a body cavity, and a puncturing portion provided as a puncturing means having an electrode for transmitting an image signal for an image picked up by the image pickup unit is placed by piercing a body wall. The image signal for the body cavity image picked up by the image pickup unit is transmitted through the electrode of the puncturing portion placed by piercing the body wall.

The present invention is not limited to the above-described embodiments. Various changes and modifications of the embodiments can be made without departing from the gist of the present invention.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An endoscope system comprising:
an image pickup unit for picking up an image in a body cavity; and
a puncturing portion having an electrode for transmitting a signal picked up by the image pickup unit, the puncturing portion transmitting the signal from the image pickup unit to the outside of the body cavity through a body wall.

2. The endoscope system according to claim 1, wherein the puncturing portion having a distal end portion formed so as to be pointed, is connected to the image pickup unit, and makes the distal end portion pierced through the body wall from the body cavity to establish an electrical connection with a control unit outside the body cavity.

3. The endoscope system according to claim 1, wherein the puncturing portion having the distal end portion formed so as to be pointed, makes the distal end portion pierced through the body wall from the outside of the body cavity to establish an electrical connection with the image pickup unit in the body cavity, and establishes an electrical connection with a control unit outside the body cavity.

4. The endoscope system according to claim 2, further comprising a stopper member for fixing the puncturing portion to an abdominal wall, outside of the body cavity.

5. The endoscope system according to claim 1, further comprising a detachable cover member with which at least a part of the image pickup unit is covered.

6. The endoscope system according to claim 2, further comprising a detachable cover member with which at least a part of the image pickup unit is covered.

7. The endoscope system according to claim 3, further comprising a detachable cover member with which at least a part of the image pickup unit is covered.

8. The endoscope system according to claim 4, further comprising a detachable cover member with which at least a part of the image pickup unit is covered.

9. A camera set on body cavity inner wall, comprising:
an image pickup portion which picks up an image in a body cavity;
a signal transmitting portion pierced through a body wall, which transmits a signal from the image pickup portion to the outside of the body cavity;
a base portion provided integrally with the image pickup portion and formed of an elastic member larger in diameter than the image pickup portion;
a cover portion in the form of a sack formed integrally with the base portion and covering the signal transmitting portion extended from the image pickup portion on an extended portion side of the signal transmission portion; and
a stopper member having an engagement portion to be engaged into the signal transmitting portion.

10. The camera set on body cavity inner wall according to claim 9, further comprising an outer cover formed of an elastic member placed in a small dissected portion formed in an abdominal wall.

11. The camera set on body cavity inner wall according to claim 10, wherein the outer cover includes:
a central channel forming portion which is extendable against an elastic force of the elastic member, and which provides a communication between an inner surface side and an outer surface side of a body cavity wall; and
a disk-shaped portion placed at respective ends of the central channel forming portion, larger in diameter than the channel forming portion, and respectively placed on the inner surface and the outer surface of the body cavity wall.

12. The endoscope system according to claim 1, further comprising a display control unit which is provided outside the body cavity, and which receives a signal from the image pickup unit and outputs an image signal picked up by the image pickup unit to a display device and makes the display device display the image signal.

13. A method of setting a camera set on body cavity inner wall on an inner surface of a body cavity wall, comprising:
a manual operation to place, in a small dissected portion formed in a body cavity wall, an outer cover having a central channel forming portion which enables communication between an inner surface side and an outer surface side of the body cavity wall;
a manual operation to introduce an image pickup portion which picks up an image in a body cavity from the outer surface side to the inner surface side of the body cavity wall via the central channel forming portion of the outer cover by placing a finger in a cover portion which is provided integrally with the image pickup portion and which covers a signal transmitting portion extended from the image pickup portion on an extended portion side of the signal transmitting portion;
a manual operation to adjust an image pickup range of the image pickup portion by operating at least one of the cover portion, the signal transmitting portion and the outer cover so that a base portion provided integrally with the image pickup portion introduced into the inner surface side of the body cavity wall is drawn into abutment on an inner surface of the body cavity wall; and
a manual operation to position the image pickup portion by causing an engagement portion of a stopper member to engage into the signal transmitting portion of the image pickup portion whose image pickup range is adjusted.
